(19) United States
(12) Patent Application Publication
(10) Pub. No.: US 2006/0068987 A1
(43) Pub. Date: Mar. 30, 2006

(54) Carbon supported catalyst having reduced water retention

(76) Inventors: Srinivas Bollepalli, Marietta, GA (US); Anderson O. Dotson, Marietta, GA (US); Sanket Desai, Marietta, GA (US); George A. Joyce, Ball Ground, GA (US); Kevin W. Hathcock, Woodstock, GA (US); Rodney L. Taylor, Acworth, GA (US)

Correspondence Address: NEEDLE & ROSENBERG, P.C., SUITE 1000, 999 PEACHTREE STREET, ATLANTA, GA, 30309-3915, US

(21) Appl. No.: 11/093,858

(22) Filed: Mar. 30, 2005

Related U.S. Application Data
(60) Provisional application No. 60/613,064, filed on Sep. 24, 2004.

(51) Int. Cl. B01J 21/18; H01M 4/86

(52) U.S. Cl. 502/182; 502/185; 429/40

(57) ABSTRACT

Compositions are disclosed for carbon supported catalysts with high metal loadings, high electrochemically active surface area, and good water management properties. In one aspect, the invention is directed to a carbon supported catalyst comprising a carbonaceous substrate and a dispersed metal, wherein the carbonaceous substrate has an electron microscopy surface area to nitrogen surface area ratio of at least 0.5 and a nitrogen surface area of at least 100 m²/g.

### CROSS REFERENCE TO RELATED APPLICATIONS

This application claims priority to U.S. Provisional Application Ser. No. 60/613,064 filed Sep. 24, 2004, hereby incorporated by reference in its entirety.

### BACKGROUND OF THE INVENTION

1. Field of the Invention

This invention relates to carbon supported catalysts. In one aspect, the catalysts are for fuel cell applications.

2. Background

A fuel cell is a device that converts energy of a chemical reaction into electrical energy. Polymer electrolyte membrane fuel cells (PEMFC) have a proton conductive polymer membrane electrolyte positioned between electrocatalysts (a cathode and an anode). An electrocatalyst is used to induce the desired electrochemical reactions at the electrodes. The electrocatalyst is typically a noble metal supported on a carbonaceous substrate, such as, for example, a platinum black or platinum supported on carbon catalyst. The electrocatalyst is typically incorporated at the electrode/electrolyte interface by coating a slurry of the electrocatalyst particles onto the electrolyte surface.

When the fuel, such as, hydrogen fuel, is fed through the anode electrocatalyst/electrolyte interface, an electrochemical reaction occurs, generating protons and electrons. The electrically conductive anode is connected to an external circuit, which carries electrons producing an electric current.

The polymer electrolyte is typically a proton conductor, and protons generated at the anode migrate through the electrolyte to the cathode. At the cathode, the protons combine with electrons and oxygen to give water.

Since the fuel cell catalyst metal, typically platinum, is extremely expensive, it is desirable to achieve the highest surface area of metal per gram of metal utilized in formulating the catalyst. Several well-known techniques exist for depositing metals on carbon supports. For example, the support can be dispersed in an aqueous solution of chloroplatinic acid, dried, and exposed to hydrogen.

Traditionally, conductive carbon blacks (e.g. Columbian Conductex® 975 or CDX-975, available from Columbian Chemicals, Marietta, Ga.) have been used as fuel cell catalyst supports. In fuel cell applications, it is required that the catalyst support material be electrically conductive. In other applications, electrical conductivity is not necessarily required. Furthermore, deposition of noble metals onto the surface of carbon black particles typically requires the use of carbon blacks with reasonably high surface areas (greater than 200 m²/g). This is not an absolute requirement, as the requisite surface area is proportional to the desired metal loading. For example, a 20% (by weight) platinum on carbon black catalyst would require less available carbon surface area than a similarly prepared 50% platinum on carbon black catalyst. To achieve high metal loadings (e.g. 50%), the typical practice is to utilize a high surface area carbon material, such as Ketjen black (Ketjen EC-300 or EC-600, available from Ketjen Black International, Japan). The use of catalysts with higher metal loadings allows the use of less catalyst material to achieve a desired amount of metal in the electrode layer, and thus, thinner electrode layers.

High surface area carbon blacks can be achieved by either producing extremely fine carbon blacks with small primary particle sizes, or by producing porous carbon blacks which exhibit varying degrees of porosity. One means by which porosity can be described is the ratio of Electron Microscopy Surface Area to Nitrogen Surface Area (EMSA/NSA), with more porous carbon blacks having lower ratios. Unfortunately, highly porous carbon blacks, such as Ketjen blacks, also absorb water more readily and to a greater extent, than do less porous carbon blacks. Water uptake and retention can be problematic in fuel cells, resulting in flooded cells wherein the transport of gaseous reactants is reduced or constricted.

Therefore, there exists a need in the art to produce fuel cell catalysts that can support high metal loadings while also providing high electrochemically active surface area values, as defined herein below, and concurrently avoiding water retention problems, which can result in flooding.

### SUMMARY

In one aspect, the invention relates to a carbon supported catalyst comprising a carbonaceous substrate and a dispersed metal, wherein the carbonaceous substrate has an electron microscopy surface area to nitrogen surface area ratio of at least 0.5 and a nitrogen surface area of at least 100 m²/g.

In yet another aspect, the invention relates to a catalytic fuel cell comprising the carbon supported catalyst of the invention.

Additional advantages will be set forth in part in the description which follows, and in part will be obvious from the description, or can be learned by practice of the aspects described below. The advantages described below will be realized and attained by means of the elements and combinations particularly pointed out in the appended claims. It is to be understood that both the foregoing general description and the following detailed description are exemplary and explanatory only and are not restrictive.

### BRIEF DESCRIPTION OF THE DRAWING(S)

The accompanying drawing, which is incorporated in and constitutes a part of this specification, illustrates several aspects described below. Like numbers represent the same elements throughout the figures.

FIG. 1 is a graph comparing the percent coverage of a carbon surface for Conductex® 975, Raven® 3600 Ultra, and Ketjen EC-600, when covered with spherical 2 nm platinum particles at various Pt loadings. Assumptions: CB density=1.8, 2 nm Pt particles, monodisperse Pt spheres with density 21.45 g/cc. A monolayer of close-packed Pt spheres can “cover” no more than about pi/(2*sqrt(3)), or 90.7%, of the surface (calculated for the limit that the Pt spheres are quite small compared to the carbon black particle).

### DETAILED DESCRIPTION

Before the present compounds, compositions, articles, devices, and/or methods are disclosed and described, it is to be understood that the aspects described below are not limited to specific synthetic methods, or specific catalysts as such can, of course, vary. It is also to be understood that the terminology used herein is for the purpose of describing particular aspects only and is not intended to be limiting.

Disclosed are materials, compounds, compositions, and components that can be used for, can be used in conjunction with, can be used in preparation of, or are products of the disclosed method and compositions. These and other materials are disclosed herein, and it is understood that when combinations, subsets, interactions, groups, etc. of these materials or processes are disclosed that while specific reference of each various individual and collective combinations and permutations of these compounds or processes can not be explicitly disclosed, each is specifically contemplated and intended herein.

In this specification and in the claims which follow, reference will be made to a number of terms which shall be defined to have the following meanings.

It must be noted that, as used in the specification and the appended claims, the singular forms “a,” “an” and “the” include plural referents unless the context clearly dictates otherwise. Thus, for example, reference to “a metal” includes mixtures of metals, reference to “a base” includes mixtures of two or more bases, and the like.

“Optional” or “optionally” means that the subsequently described event or circumstance can or cannot occur, and that the description includes instances where the event or circumstance occurs and instances where it does not.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

A weight percent of a component, unless specifically stated to the contrary, is based on the total weight of the formulation or composition in which the component is included.

“Metal” as used herein can be, e.g., one or more of a precious metal, a noble metal, a platinum group metal, platinum, an alloy or oxide of any of the above, or a composition that includes a transition metal or oxide of any of the above. As used herein, it is a “metal” that acts as a catalyst for the reactions occurring in the fuel cell or other catalytic operation. The metal can be tolerant of CO containing contaminants and can also be used in direct methanol fuel cells.

“Carbonaceous” refers to a solid material comprised substantially of elemental carbon. “Carbonaceous material” is intended to include, without limitation, i) carbonaceous compounds having a single definable structure; or ii) aggregates of carbonaceous particles, wherein the aggregate does not necessarily have a unitary, repeating, and/or definable structure or degree of aggregation.

“Carbon black” is a conductive acinoform carbon utilized, for example, as a catalyst support.

“Support” or “carbon support” refers to a carbonaceous material onto which a metal or catalytic material is dispersed.

“Particulate” means a material of separate particles.

“X-ray diffraction” (XRD) is an analysis method for determining crystallographic properties of a material, specifically as used herein the size of dispersed metal particles.

“NSA” or “Nitrogen Surface Area” refers to an average surface area measurement obtained by nitrogen adsorption, according to ASTM D6556. Thus, as reported herein, NSA refers to an average value for the carbonaceous material.

“EMSA” or “Electron Microscopy Surface Area” refers to an average surface area measurement obtained by transmission electron microscopy, according to ASTM D3849, which does not factor in surface porosity. Thus, as reported herein, EMSA refers to an average value for the carbonaceous material. EMSA is inversely related to particle size without regard for porosity.

“ECSA” or “Electrochemically Active Surface Area” is an electrochemical measurement of the accessible metal surface area of a catalyst.

The present invention describes the use of non-traditional carbon blacks and other carbonaceous materials for catalyst supports, based on the surface area available for metal deposition. As described above, common practice is to employ high surface area carbon supports to achieve high metal loadings on catalysts. This approach, unfortunately, also results in water management problems in fuel cells when the higher surface area sought is obtained via use of highly porous supports, such as Ketjen black. It is possible to deposit similar loadings (e.g. 50%) of metals, such as platinum, onto a traditional carbon black support (e.g. Conductex® 975), although a corresponding increase in the electrochemically active surface area (ECSA) of platinum metal does not result because of the limited available carbon black surface area. Therefore, the industry is faced with either using catalysts on traditional supports at lower loadings, typically 40% or less, or using porous high surface area supports and enduring complicating water management problems. The present invention employs the use of carbon supports that allow heretofore unavailable high metal loadings with concurrent good metal dispersions, high ECSA values, and good water management properties.

Surface Area Measurement Techniques

Traditional surface area measurements for carbonaceous materials are performed via nitrogen surface area (NSA) techniques (ASTM D6556).

Electron Microscopy Surface Area (EMSA) (ASTM D3849) is yet another technique by which surface area of carbonaceous materials, and in particular, carbon blacks, can be measured. A software algorithm is utilized to analyze transmission electron micrographs of carbon blacks.

NSA takes into account both particle size and porosity of the carbonaceous material whereas EMSA accounts for particle size independent of porosity.

Surface Coverage/Available Surface Area

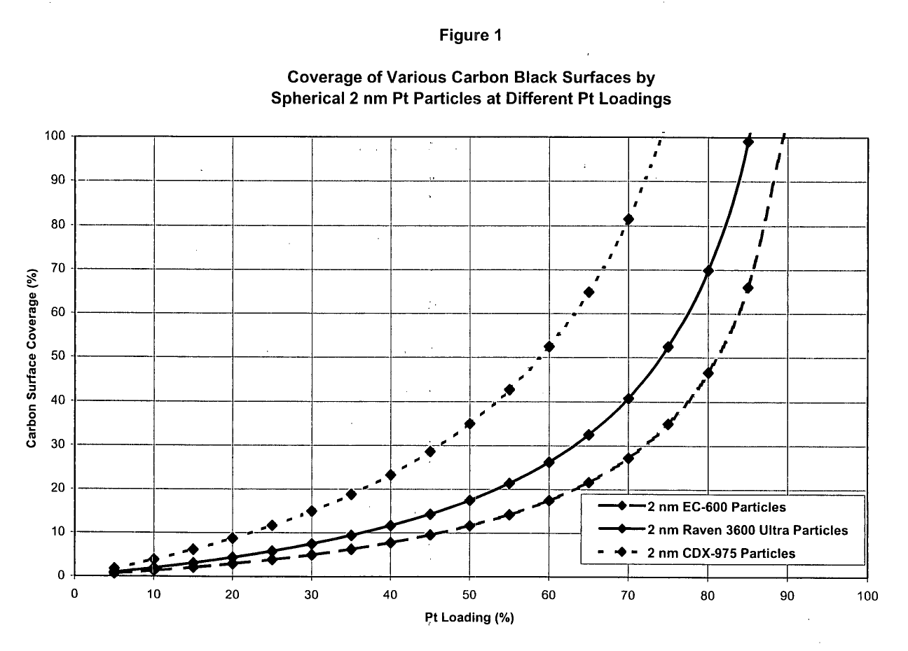

For a given carbon black utilized as a catalyst support, the ability to deposit a given quantity of metal is dependent on the available surface area of the carbon (as determined by EMSA). For a given metal particle size, as the metal loading increases, the percentage of the carbon surface covered by metal also increases. It becomes inherently difficult to deposit small metal particles at a coverage level of greater than approximately 30 percent. At 50% platinum loading of 2 nm particles on a traditional carbon support (Conductex® 975), approximately 35% of the Conductex® 975 surface is covered. In contrast, a similar loading of 2 nm particles only covers approximately 18% of the surface of Raven® 3600 Ultra carbon black (available from Columbian Chemicals Company, Marietta, Ga.), and approximately 12% of the surface of a Ketjen EC-600 carbon. FIG. 1 compares the metal loading/surface coverage relationship between these three carbons for 2 nm platinum particles.

EMSA, NSA, and Ratio of EMSA to NSA

Having described carbon surface area measurement techniques and surface coverage values, it is important to analyze the relationship of EMSA to NSA. The difference between EMSA and NSA is typically an indicator of the amount of porosity inherent to a given carbon black surface. This can also be expressed as the ratio of EMSA to NSA, a higher value indicating less porosity, and greater percentage of the NSA surface area available for metal coverage.

In various aspects of the invention, a carbonaceous substrate of the present invention has an EMSA/NSA ratio of at least 0.5, at least 0.6, at least 0.7, from 0.5 to 0.95, or from 0.7 to 0.85. In other aspects, the carbonaceous substrate has an EMSA/NSA ratio of from 0.5 to 1.0, for example, 0.5, 0.55, 0.6, 0.65, 0.7, 0.75, 0.8, 0.85, 0.9, 0.95, 0.99, or 1.0 can be used.

In various aspects of the invention, a carbonaceous support of the present invention has a nitrogen surface area of at least 100 m²/g, at least 200 m²/g or from 200 to 1400 m²/g. In other aspects of the invention, the carbonaceous support has a nitrogen surface area of from 100 to 1400 m²/g, for example, 100, 150, 200, 220, 240, 250, 300, 350, 400, 450, 500, 550, 600, 650, 700, 750, 800, 850, 950, 1000, 1100, 1200, 1300, or 1400 m²/g can be used.

In one aspect of the invention, a carbonaceous substrate of the present invention has an EMSA of at least 80 m²/g. In other aspects of the invention, the carbonaceous substrate has an EMSA value of from 80 m²/g to 500 m²/g, for example, 80, 90, 100, 120, 150, 180, 200, 250, 300, 250, 400, or 500 m²/g can be used. There is no theoretical upper limit to the desired EMSA. As the EMSA value cannot be theoretically higher than the NSA value, the maximum EMSA/NSA ratio is 1.0.

In another aspect of the invention, the carbonaceous substrate has an EMSA/NSA ratio of from 0.7 to 0.85, an NSA of from 200 to 400 m²/g, and an EMSA of from 140 to 340 m²/g.

In another aspect of the invention, the carbonaceous substrate has an EMSA/NSA ratio of from 0.73 to 0.83, an NSA of 205 to 301 m²/g, and an EMSA of from 150 to 250 m²/g.

Example 1 details surface area measurements obtained on various carbon supports. While Columbian's Raven® 3600 Ultra has an NSA value similar to that of a traditional support (Conductex® 975), it has less porosity, and thus a greater amount of available external surface area. In another aspect, it has a higher EMSA/NSA ratio than do either of the traditional carbon supports. This higher ratio provides a greater ability to disperse high metal loadings on the support surface while maintaining high electrochemical surface area values.

Example 2 describes the ECSA values obtained on various catalysts. After depositing platinum particles on the support surface, this value represents the amount of metal surface available for catalytic activity. On traditional supports like Conductex® R975, the ECSA drops substantially as the metal loading increases, especially above 40%. The Ketjen black catalyst maintains a high ECSA value at 50% metal loading, but brings significant water management issues that can interfere with fuel cell performance. By employing a support with a high EMSA/NSA ratio, higher loadings can be achieved that maintain high ECSA values (approximately equivalent to those obtained on high surface area, porous carbons, e.g. Ketjen blacks), without introducing water management problems.

Porosity and Water Uptake

As described above, water management problems can be detrimental in many catalyst environments, especially in fuel cells. In various aspects of the invention, the carbonaceous substrate has a maximum water absorption less than about 10%, less than 8%, less than 7%, or from 6% to 7%, all at 70° C. and at a partial water pressure of 0.9.

Carbonaceous Material

The carbonaceous support material typically has the traditional requisite fuel cell catalyst properties of low impurities, low elemental sulfur concentration, and reasonable electrical conductivity.

The carbonaceous material can be any particulate, substantially carbonaceous material that is an electronically conductive carbon and has a “reasonably high” surface area. For example, carbon black, graphite, nanocarbons, fullerenes, fullerenic material, finely divided carbon, or mixtures thereof can be used. The carbonaceous substrate can be substituted, such as with sulfonated groups. Such sulfonated substituted carbon black is shown in WO 2003/100889, which publication is herein incorporated by reference in its entirety and for its teachings of sulfonated substituted carbon black.

Carbon Black

The carbonaceous material can be carbon black. The choice of carbon black in the invention is significant to achieving the desired results described herein. Carbon blacks with nitrogen surface areas (NSA, ASTM D6556) of about 100 to about 1400 m²/g, for example, about 100, 150, 200, 220, 240, 250, 300, 350, 400, 450, 500, 550, 600, 650, 700, 750, 800, 850, 950, 1000, 1100, 1200, 1300, or 1400 m²/g can be used. In one aspect, a carbon black with a surface area of 250 m²/g can be used. It is preferred that the carbon black have a fineness (small particle size) effective for metal dispersion. It is preferred that the carbon black have structure effective for gas diffusion.

Carbon blacks with EMSA values (ASTM D3849) of about 80 m²/g to about 500 m²/g, for example, about 80, 90, 100, 120, 150, 180, 200, 250, 300, 250, 400, or 500 m²/g can be used. In one aspect, a carbon black with an EMSA of 80 m²/g can be used.

Carbon blacks having a ratio of EMSA to NSA (EMSA/NSA) of at least 0.5 can be used, preferably 0.6 or greater, most preferably 0.7 of greater; for example, carbon blacks having a EMSA/NSA ratio of about 0.5, 0.55, 0.6, 0.65, 0.7, 0.75, 0,8 0.85, 0.9, 0.95, 0.99, or 1.0 can be used.

The carbon black can be greater than about 0% to about 100% by weight of the composition of the present invention, for example, about 2, 5, 10, 15, 20, 25, 30, 35, 40, 45, 50, 55, 60, 65, 70, 75, 80, 85, 90, 95, 96, or 97%. The carbon black can be about 1% to about 90% by weight of the composition, for example, about 2, 5, 10, 12, 15, 17, 20, 22, 25, 27, 30, 32, 35, 37, 40, 42, 45, 47, 50, 52, 55, 57, 60, 62, 65, 67, 70, 72, 75, 77, 80, 82, 85, 87, or 88%. The carbon black can be about 40% to about 90% by weight of the composition, for example, about 41, 44, 46, 50, 51, 54, 56, 60, 61, 64, 66, 70, 71, 74, 76, 80, 81, 84, 86, or 89%. The carbon black can be about 50% to about 80% by weight of the composition, for example, about 53, 54, 55, 57, 58, 60, 63, 65, 67, 68, 70, 73, 75, 77, 78, or 79%, of the present invention.

Those skilled in the art will appreciate that carbon black particles have physical and electrical conductivity properties which are primarily determined by the particle and aggregate size, aggregate shape, degree of graphitic order, and surface chemistry of the particle.

Also, the conductivity of highly crystalline or highly graphitic particles is higher than the conductivity of more amorphous particles. Generally, any of the forms of carbon black particles is suitable in the practice of the present invention and the particular choice of size, structure, and degree of graphitic order depends upon the physical and conductivity requirements desired for the carbon black.

One of skill in the art could readily choose an appropriate carbon black for a particular application.

Various carbon blacks are commercially available (e.g., Columbian Chemical Company, Atlanta, Ga.). In one aspect of the invention, the carbon black is Raven® 3600 Ultra. Raven® 3600 Ultra has an average oil absorption number of 130 (ASTM D2414); an average primary particle size of 11 nm (ASTM D3849); an average elemental sulfur content of 0.3% (via combustion method); an average volatile content of 1.5% (as measured by loss of carbon black at 950° C. at 15 minutes); an NSA of 257 m²/0±10 m²/g; and an EMSA of 200 m²/g±10 m²/g.

In another aspect of the invention, the carbon black has an average primary particle size of from 9 to 13 nm; a nitrogen surface area of from 247 to 267 m²/g; and an electron microscopy surface area of from 190 to 210 m²/g.

Other Carbonaceous Material

The particulate carbonaceous material can be a material other than carbon black. The choice of other carbonaceous material in the invention is not critical. Any substantially carbonaceous material that is an electronically conductive carbon and has a “reasonably high” surface area can be used in the invention. For example, graphite, nanocarbons, fullerenes, fullerenic material, finely divided carbon, or mixtures thereof can be used.

It is preferred that the carbonaceous material have fineness effective for metal dispersion. It is preferred that the carbonaceous material have structure effective for gas diffusion.

One of skill in the art could readily choose a carbonaceous material for a particular application. Various carbonaceous materials are commercially available.

The carbonaceous material can be greater than about 0% to about 100% by weight of the composition of the present invention, for example, about 2, 5, 10, 15, 20, 25, 30, 35, 40, 45, 50, 55, 60, 65, 70, 75, 80, 85, 90, 95, 96, or 97%. The carbonaceous material can be about 1% to about 90% by weight of the composition, for example, about 2, 5, 10, 12, 15, 17, 20, 22, 25, 27, 30, 32, 35, 37, 40, 42, 45, 47, 50, 52, 55, 57, 60, 62, 65, 67, 70, 72, 75, 77, 80, 82, 85, 87, or 88%. The carbonaceous material can be about 40% to about 90% by weight of the composition, for example, about 41, 44, 46, 50, 51, 54, 56, 60, 61, 64, 66, 70, 71, 74, 76, 80, 81, 84, 86, or 89%. The carbonaceous material can be about 50% to about 80% by weight of the composition, for example, about 53, 54, 55, 57, 58, 60, 63, 65, 67, 68, 70, 73, 75, 77, 78, or 79%, of the present invention.

Metal/Source of Metal Ions

The composition or catalyst of the present invention further comprises a metal. Metal is defined above. The metal can be, for example, platinum, iridium, osmium, rhenium, ruthenium, rhodium, palladium, vanadium, chromium, or a mixture thereof, or an alloy thereof. In one aspect, the metal is platinum.

As defined above, the metal can also be alloys or oxides of metals effective as catalysts.

It is desired that the form and/or size of the metal provide the highest surface area of the metal possible per unit mass. It is desired that the size of the metal particles be kept as small as possible to achieve this end. Generally, in the art, average metal particle sizes end up as approximately 2 to about 6 nm during use in fuel cells due to sintering. A size less than about 2 nm can provide better performance.

The amount of metal can be any amount. The amount of metal can be an effective catalytic amount. One of skill in the art can determine an amount effective for the desired performance.

The metal can be about 2% to about 80% of the composition, for example, about 3, 5, 7, 8, 10, 12, 13, 15, 17, 20, 22, 25, 27, 30, 32, 35, 37, 40, 42, 45, 47, 50, 52, 55, 57, 60, 62, 65, 67, 70, 72, 75, or 78%. The metal can be about 2% to about 60% of the composition, for example, about 5, 7, 10, 12, 15, 20, 25, 30, 35, 40, 45, 50, 55, or 57%. The metal can be about 20% to about 40% of the composition for example, about 22, 25, 30, 35, or 38%. The metal can be uniformly distributed on the composition, e.g., on the surface of the composition.

One of skill in the art could readily choose a metal to use in the composition for a particular application. Various metals are commercially available.

The metal can be uniformly distributed or dispersed on and/or in the carbonaceous substrate.

In one aspect, the metal particles are in nanocrystalline form. In another aspect, the metal particles, which are dispersed on a carbonatious substrate, have a narrow particle size distribution.

Addition of Metal/Metallizing

Metal is added to the carbonaceous material to produce the carbon supported catalyst of the invention. The metal can be added by metallizing, and such techniques are well known to those of skill in the art. For example, if the metal is platinum, one method of platinization is described below. The source of metal can be any form that can be effectively dispersed onto the substrate and subsequently reduced to an effectively metallic state.

One of skill in the carbonaceous art would know how to make the carbon supported catalyst of the invention. In one aspect, the method of making the carbon supported catalyst of the invention can be any prior art method of metallizing a carbonaceous material. Such processes are disclosed in, for example, U.S. Pat. No. 4,081,409; U.S. Pat. No. 5,316,990; U.S. Pat. No. 5,759,944; and U.S. Pat. No. 5,767,036, which documents are hereby incorporated by reference in their entireties.

In another aspect of the invention, the method of making a carbon supported catalyst of the invention can be a process comprising
a. mixing a carbonaceous substrate, a source of metal ions, a base, and a reducing agent for the metal ions, to form a mixture, wherein the carbonaceous substrate an electron microscopy surface area to nitrogen surface area ratio of at least approximately 0.5 and a nitrogen surface area of at least 100 m²/g;
b. heating the mixture of step (a) to at least a sufficient temperature to cause substantial reduction of the metal ions to metal on the carbonaceous substrate; and
c. washing and drying the product of step (b).
   In one aspect of this process, the carbonaceous substrate and the source of metal ions are mixed first, followed by addition of the base and the reducing agent.
   Platinizing

A platinizing agent can be used to add platinum to the carbonaceous material. Various platinizing agents are known in the art. These platinizing agents are readily commercially available or readily synthesized by methods known to one of skill in the art. The choice of appropriate platinizing agent is readily determined by one of skill in the art for the desired application. Generally, anything containing the desired metal can be used, for example, any salt or organo-compound containing the metal. Examples of platinizing agents that can be used include platinum salts, such as, but not limited to, chloroplatinic acid, platinum nitrate, platinum halide, platinum cyanide, platinum sulfide, organoplatinum salt, or a combination thereof. The amount of platinizing agent is readily determined by one of skill in the art for a desired application. Standard methods for depositing or precipitating metals onto carbon supports are well known in the art.

### EXAMPLES

The following examples are put forth so as to provide those of ordinary skill in the art with a complete disclosure and description of how the compounds, compositions, articles, devices, and/or methods described and claimed herein are made and evaluated, and are intended to be purely exemplary and are not intended to limit the scope of what the inventors regard as their invention. Efforts have been made to ensure accuracy with respect to numbers (e.g., loadings, surface areas, etc.) but some errors and deviations should be accounted for. Unless indicated otherwise, percents are weight percents.

### Example 1

Surface area measurements were obtained on various carbon supports using nitrogen surface area (NSA, ASTM D6556) and electron microscopy surface area (EMSA, ASTM D3849). The results are set forth below in Table I. Other analytical data for Raven® 3600 Ultra is: average oil absorption number 130 (ASTM D2414); average primary particle size, 11 nm (ASTM D3849); average elemental sulfur content, 0.3% (via combustion method); and average volatile content, 1.5% (as measured by loss of carbon black at 950° C. at 15 minutes).

TABLE I

| Carbon Black | NSA (m²/g) | EMSA (m²/g) | EMSA/NSA Ratio |
|---|---|---|---|
| Conductex ® 975 | 250 | 100 | 0.40 |
| Raven ® 3600 Ultra | 257 | 200 | 0.78 |
| Ketjen EC-600 | 925 | 300 | 0.32 |

### Example 2

Fuel cell catalysts were prepared at various metal loadings, as listed below in Table II, according to conventional metal precipitation techniques utilizing various carbon supports. Measurements of electrochemically available surface area were then performed according to the following procedure.

Inks were prepared of each catalyst listed in Table II, by weighing approximately 200 mg of dry catalyst into a small vial. An amount of deionized distilled water was added, corresponding to approximately 8.6 times the weight of catalyst. An identical weight of Nafion (1100 equivalent weight, 5% solution, available from Sigma Aldrich, Milwaukee, Wis.) solution was subsequently added. The resulting mixture was stirred for approximately twenty minutes, followed by sonication for ten minutes, followed by a subsequent stirring step for twenty minutes.

Electrodes were prepared from the previously prepared inks by spraying the ink onto both sides of a piece of known weight carbon paper (approximately 5×1.5 cm²) that had been previously dried at 110° C. for at least ten minutes. The coated paper was dried in air, followed by drying at 110° C. for approximately ten to twenty minutes, after which time, the paper was again weighed.

The electrode (coated paper) was placed in a bottle and covered with 2 M CH₃OH (available from Sigma Aldrich, Milwaukee, Wis.). The bottle containing the solution and electrode was placed in a vacuum chamber (vacuum oven at ambient temperature can also be used), and vacuum was applied until no bubbles were observed on the electrode surface. The electrode was then removed and washed with deionized, distilled water.

The washed electrode was then placed in an electrochemical cell containing a Ag/AgCl/Cl-reference electrode and a gold electrode holder. The electrode was treated as the working electrode of the electrochemical cell. Cyclic voltammetry was performed under the following conditions: potential sweep from −0.25 V to +1.0 V vs reference at a scan rate of 15 mV/sec, 5 cycles per scan. The voltammetry was repeated, and if reproducible, the last cycle was utilized to calculate the electrochemically active surface area.

To calculate the electrochemically active surface, the total charge passed on the cathodic scan, from the double layer region to the last peak in the potential scan rage, was integrated. The surface area was then calculated by the following equation:

ECSA (m²/g)=Charge passed (c)*100/210/platinum weight (g). The same approach was used to integrate and calculate the charge and surface area from the anodic scan (from the first peak to the double layer region). The anodic and cathodic surface area numbers were then averaged. The results from this technique on the prepared catalysts are listed in Table II.

TABLE II

| Catalyst | Carbon Black | Platinum Loading | ECSA (m²/g) |
|---|---|---|---|
| A | Conductex ® 975 | 40% | 76 |
| B | Conductex ® 975 | 50% | 58 |
| C | Ketjen EC-600 | 50% | 78 |
| D | Raven ® 3600 Ultra | 50% | 80 |

### Example 3

Water adsorption isotherms were acquired at 70° C. for the three carbon supports referenced above (except that Ketjen EC-300 was used instead of Ketjen EC-600). Maximum values were obtained for all uncatalyzed (un-metallized) supports at partial pressures of water of 0.9 (P/P₀), which approximates fuel cell conditions. The maximum uptake for the traditional support (Conductex® 975) was 7.51%, while that of a Ketjen black (EC-300) was 38.8% due to its highly porous surface. The Raven® 3600 Ultra support, which has a high EMSA/NSA ratio, performed much like the traditional support, with a maximum water uptake of 6.37%. It should be noted that Ketjen EC-300 black is expected to be slightly less porous and thus have lower water uptake, than Ketjen EC-600.

### Example 4

An 8 gram sample of 50% platinum on Raven® 3600 Ultra catalyst can be prepared according to the following process:
(a) 4 g of Raven® 3600 Ultra carbon black (available from Columbian Chemicals Company, Marietta, Ga.) are added to a vessel containing 500 mls of distilled water;
(b) followed by stirring to adequately wet and disperse the carbon black;
(c) chloroplatinic acid equivalent to 4 g of platinum (available from VWR, West Chester, Pa.), are added to the resulting mixture followed by stirring;
(d) 300 mls of 2.0 N sodium hydroxide solution (available from VWR, West Chester, Pa.) are added to the resulting mixture, followed by stirring;
(e) supernate is decanted from the reaction vessel; and
(f) the mixture is dried by flowing a stream of hydrogen, heated to a temperature between 250 and 500° C.

Throughout this application, various publications are referenced. The disclosures of these publications in their entireties are hereby incorporated by reference into this application in order to more fully describe the compounds, compositions and methods described herein.

Various modifications and variations can be made to the compounds, compositions and methods described herein. Other aspects of the compounds, compositions and methods described herein will be apparent from consideration of the specification and practice of the compounds, compositions and methods disclosed herein. It is intended that the specification and examples be considered as exemplary.

What is claimed is:

1. A carbon supported catalyst comprising a carbonaceous substrate and a dispersed metal, wherein the carbonaceous substrate has an electron microscopy surface area to nitrogen surface area ratio of at least 0.5 and a nitrogen surface area of at least 100 m²/g.

2. The carbon supported catalyst of claim 1, wherein the carbonaceous substrate has an electron microscopy surface area to nitrogen surface area ratio of from 0.5 to 0.95.

3. The carbon supported catalyst of claim 1, wherein the carbonaceous substrate has an electron microscopy surface area to nitrogen surface area ratio of at least 0.6.

4. The carbon supported catalyst of claim 1, wherein the carbonaceous substrate has an electron microscopy surface area to nitrogen surface area ratio of at least 0.7.

5. The carbon supported catalyst of claim 1, wherein the carbonaceous substrate has an electron microscopy surface area to nitrogen surface area ratio of from 0.7 to 0.85.

6. The carbon supported catalyst of claim 1, wherein the carbonaceous substrate has a nitrogen surface area of at least 200 m²/g.

7. The carbon supported catalyst of claim 1, wherein the carbonaceous substrate has a nitrogen surface area of from 200 to 1400 m²/g.

8. The carbon supported catalyst of claim 1, wherein the carbonaceous substrate has an electron microscopy surface area of at least 80 m²/g.

9. The carbon supported catalyst of claim 1, wherein the carbonaceous substrate has an electron microscopy surface area of from 80 to 500 m²/g.

10. The carbon supported catalyst of claim 1, wherein the carbonaceous substrate has an electron microscopy surface area to nitrogen surface are ratio of from 0.7 to 0.85, a nitrogen surface area of from 200 to 400 m²/g, and an electron microscopy surface area of from 140 to 340 m²/g.

11. The carbon supported catalyst of claim 1, wherein the carbonaceous substrate has an electron microscopy surface area to nitrogen surface area ratio of from 0.73 to 0.83, a nitrogen surface area of from 205 to 301 m²/g, and an electron microscopy surface area of from 150 to 250 m²/g.

12. The carbon supported catalyst of claim 1, wherein the carbonaceous substrate comprises carbon black.

13. The carbon supported catalyst of claim 1, wherein the carbonaceous substrate comprises substituted carbon black.

14. The carbon supported catalyst of claim 1, wherein the carbonaceous substrate comprises sulfonated carbon black.

15. The carbon supported catalyst of claim 1, wherein the carbonaceous substrate has a maximum water absorption less than 10% at 70° C. and at a partial water pressure of 0.9.

16. The carbon supported catalyst of claim 1, wherein the carbonaceous substrate has a maximum water absorption less than 8% at 70° C. and at a partial water pressure of 0.9.

17. The carbon supported catalyst of claim 1, wherein the carbonaceous substrate has a maximum water absorption less than 7% at 70° C. and at a partial water pressure of 0.9.

18. The carbon supported catalyst of claim 1, wherein the carbonaceous substrate has a maximum water absorption of from 6% to approximately 7% at 70° C. and at a partial water pressure of 0.9.

19. The carbon supported catalyst of claim 1, wherein the carbonaceous substrate is Raven® 3600 Ultra carbon black.

20. The carbon supported catalyst of claim 1, wherein the carbonaceous substrate comprises a carbon black having an average primary particle size of from 9 to 13 nm; a nitrogen surface area of from 247 to 267 m²/g; and an electron microscopy surface area of from 190 to 210 m²/g.

21. The carbon supported catalyst of claim 1, wherein the metal comprises platinum.

22. The carbon supported catalyst of claim 1, wherein the catalyst is a fuel cell catalyst.

23. A catalytic fuel cell comprising the carbon supported catalyst of claim 1.
